(19) United States
(12) Patent Application Publication
(10) Pub. No.: US 2025/0387706 A1
(43) Pub. Date: Dec. 25, 2025

(54) VIRTUAL ITEM DISPLAY CONTROL METHOD AND APPARATUS, AND ELECTRONIC DEVICE

(71) Applicant: NETEASE (HANGZHOU) NETWORK CO., LTD., Hangzhou, Zhejiang (CN)

(72) Inventors: Yuhang GONG, Nantong, Jiangsu (CN); Jie CHEN, Guangzhou, Guangdong (CN)

(73) Assignee: NETEASE (HANGZHOU) NETWORK CO., LTD., Hangzhou, Zhejiang (CN)

(21) Appl. No.: 18/880,301

(22) PCT Filed: Jun. 28, 2023
(86) PCT No.: PCT/CN2023/103309

§ 371 Date: Dec. 31, 2024

(30) Foreign Application Priority Data
Jul. 1, 2022 (CN) 202210775617.5

(51) Int. Cl. A63F 13/533; A63F 13/56; A63F 13/92

(52) U.S. Cl. CPC A63F 13/533; A63F 13/56; A63F 13/92; A63F 2300/308

(57) ABSTRACT

A virtual item display control method, including: in response to a movement operation with respect to a first virtual item in a first item container, controlling the first virtual item to move from the first item container to a second item container; determining that an associated item of the first virtual item is located outside the second item container, and displaying an information prompt mark, where the associated item is an item used in conjunction with the first virtual item in a game battle, and the information prompt mark is used for prompting the storage state of the associated item in the first item container. Further provided are a virtual item display control apparatus, an electronic device and a machine-readable storage medium.

### CROSS REFERENCE TO RELATED APPLICATION

The present application is a U.S. National Stage of International Application No. PCT/CN2023/103309, filed on Jun. 28, 2023, which claims the benefit of priority to Chinese Application No. 202210775617.5, filed on Jul. 1, 2022, both of which are incorporated by reference herein in its entireties for all purpose.

### TECHNICAL FIELD

The present disclosure relates to the field of game technology, and in particular to a display control method, an apparatus and an electronic device for a virtual item.

### BACKGROUND

In some games, before a player participates in a game match, he/she needs to select equipment from the warehouse, such as firearms, bullets, armor, medicine, etc., put the selected equipment into a backpack, and then carry it to the game match. Some equipment needs to be used in combination, such as firearms and bullets, and the models of the equipment used in combination also need to match each other.

### SUMMARY

According to a first aspect of the embodiments of the present disclosure, there is provided a display control method for a virtual item, providing a graphical user interface through a terminal device; the graphical user interface includes an item display area of a first item container and an item display area of a second item container; where the first item container is configured to hold a virtual item possessed by a controlled virtual object outside a game match; the second item container is configured to hold a virtual item carried by the controlled virtual object into the game match; the method includes in response to a moving operation for a first virtual item in the first item container, controlling the first virtual item to move from the first item container to the second item container; and determining that an associated item of the first virtual item is located outside the second item container, and displaying an information prompt mark; where the associated item is an item used in combination with the first virtual item in the game match; and the information prompt mark is configured to prompt a storage status of the associated item in the first item container.

According to a second aspect of the embodiments of the present disclosure, there is provided an electronic device, including a processor and a memory, where the memory stores machine executable instructions that can be executed by the processor, and the processor executes the machine executable instructions to implement the display control method for the virtual item.

According to a third aspect of the embodiments of the present disclosure, there is provided a non-transitory machine-readable storage medium stores machine-executable instructions, which, when called and executed by a processor, cause the processor to implement the display control method for the virtual item.

Other features and advantages of the present disclosure will be described in the subsequent description, and partly become apparent from the description, or understood by practicing the present disclosure. The purpose and other advantages of the present disclosure are realized and obtained by the structures specifically pointed out in the description, claims and drawings.

In order to make the above-mentioned purpose, features and advantages of the present disclosure more obvious and easier to understand, the following is a detailed description of the example embodiments in conjunction with the attached drawings as follows.

### BRIEF DESCRIPTION OF THE DRAWINGS

In order to more clearly illustrate the technical solutions in the embodiments of the present disclosure or the related art, the following will briefly introduce the drawings required for use in the description of the embodiments or the related art. Obviously, the drawings described below are some embodiments of the present disclosure. For those skilled in the art, other drawings can also be obtained based on these drawings without inventive work.

FIG. 1 is a flow chart of a display control method for a virtual item provided in an embodiment of the present disclosure;

FIG. 2 is a schematic diagram of a first virtual item and an associated item provided in an embodiment of the present disclosure;

FIG. 3 is a schematic diagram of a prompt mark provided in an embodiment of the present disclosure;

FIG. 4 is a schematic diagram of another first virtual item and an associated item provided in an embodiment of the present disclosure;

FIG. 5 is a schematic diagram of another prompt mark provided in an embodiment of the present disclosure;

FIG. 6 is a schematic diagram of another prompt mark and an operation control provided in an embodiment of the present disclosure;

FIG. 7 is a schematic diagram of another prompt mark provided in an embodiment of the present disclosure;

FIG. 8 is a structural schematic diagram of a display control device for a virtual item provided in an embodiment of the present disclosure;

FIG. 9 is a schematic diagram of an electronic device provided in an embodiment of the present disclosure.

### DETAILED DESCRIPTION

In order to make the purpose, technical solution and advantages of the embodiments of the present disclosure clearer, the technical solution of the present disclosure will be described clearly and completely in conjunction with the accompanying drawings. Obviously, the described embodiments are part of the embodiments of the present disclosure, not all of the embodiments. Based on the embodiments in the present disclosure, all other embodiments obtained by those skilled in the art without inventive work are within the scope of protection of the present disclosure.

In the related art, various types of equipment are usually displayed in the warehouse in the form of thumbnails, and various types of equipment are relatively independently placed in grids in the warehouse. The thumbnails show too little information, and when a player selects equipment, he/she often need to rely on experience or detailed information of the equipment to make a choice. When the player is inexperienced or has no time to check the detailed information, for the equipment that needs to be used in combination, there might be a situation where multiple pieces of equipment that need to be used in combination are not fully selected, or multiple pieces of equipment that are supposed to be used in combination are selected, but the models of the multiple pieces of equipment do not match. Taking firearms and bullets as an example, the player may select a firearm, but forget to select the bullets installed on the firearm, or select the bullets that do not match the model of the firearm, resulting in the player carrying a firearm without bullets into the game match. In the game match, the player cannot use the firearm, which affects the player's game performance and game experience.

In view of this, the embodiments of the present disclosure provide a display control method, an apparatus and an electronic device for a virtual item, which can be applied to various games, such as shooting games, or other games that require carrying equipment to participate in the game match.

The display control method for the virtual item in one embodiment of the present disclosure can be run on a local terminal device or a server. When the display control method for the virtual item is run on a server, the method can be implemented and executed based on a cloud interaction system. The cloud interaction system includes a server and a client device.

In an embodiment, various cloud applications can be run under the cloud interaction system, such as a cloud game. Taking the cloud game as an example, the cloud game refers to a game mode based on cloud computing. In the operation mode of the cloud game, the execution entity of the game program and the presenting entity of the game screen are separated. The storage and operation of the display control method for the virtual item are completed on the cloud game server, and the role of the client device is to receive and send data and present the game screen. For example, the client device can be a display device with data transmission function close to the user side, such as a mobile terminal, a TV, a computer, a handheld computer, etc.; but the cloud game server in the cloud performs information processing. When playing the game, the player operates the client device to send an operation instruction to the cloud game server. The cloud game server runs the game according to the operation instruction, encodes and compresses the game screen and other data, returns it to the client device through the network. Finally, the game screen is decoded and output by the client device.

In an embodiment, taking the game as an example, the local terminal device stores the game program and is used to present the game screen. The local terminal device is configured to interact with the player through a graphical user interface. That is, the game program is conventionally downloaded and installed and run by the electronic device. The local terminal device can provide the graphical user interface to the player in a variety of ways. For example, it can be rendered and displayed on the display screen of the terminal, or provided to the player through holographic projection. For example, the local terminal device may include a display screen and a processor. The display screen is configured to present the graphical user interface. The graphical user interface includes the game screen. The processor is configured to run the game, generate the graphical user interface, and control the display of the graphical user interface on the display screen.

In an embodiment, the embodiment of the present disclosure provides a display control method for the virtual item, providing a graphical user interface through a terminal device, where the terminal device can be the local terminal device mentioned above, or it can be a client device in the cloud interaction system mentioned above. A graphical user interface is provided through the terminal device, and the graphical user interface can display interface content, such as a game scene screen, a communication interaction window, etc., according to the type of application started.

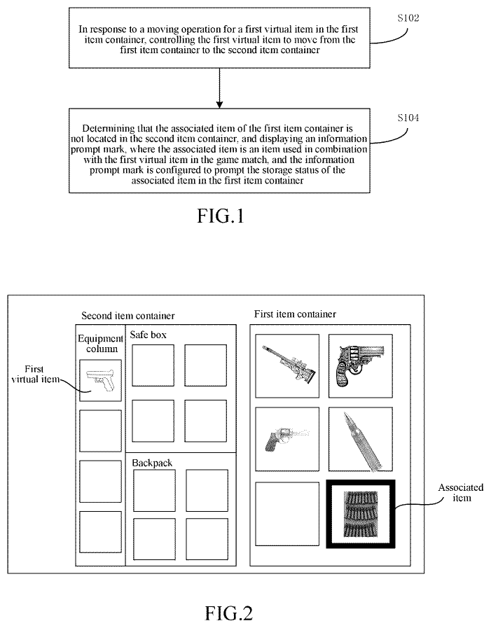

Referring to the flowchart of a display control method for a virtual item shown in FIG. 1, a graphical user interface is provided by a terminal device; the graphical user interface includes an item display area of a first item container and an item display area of a second item container; where the first item container is configured to hold a virtual item possessed by the controlled virtual object outside the game match; and the second item container is configured to hold a virtual item carried by the controlled virtual object into the game match.

Before participating in the game match, the player needs to select the virtual item to be carried into the game match. In some games, the first item container is a warehouse, and the first item container holds the virtual item owned by the player's game account, that is, virtual item possessed by the controlled virtual object controlled by the player outside the game match. The virtual item in the first item container can be virtual item purchased by the player, or the virtual item obtained by the controlled virtual object in participating in the game match, such as a virtual item picked up in the game scene, or a virtual item obtained after eliminating other virtual objects, etc. In this embodiment, the virtual item can be various weapons of the controlled virtual object, such as firearms, bullets, grenades, etc., and can also be medicines, armor, clothing, etc.

In some games, the second item container is a backpack, a safe box or an equipment area. The virtual item in the backpack, safe box or equipment area can be carried by the controlled virtual object to the game match. In the game match, the controlled virtual object can use the virtual item in the backpack.

In the aforementioned graphical user interface, it includes an item display area of the first item container and an item display area of the second item container. The virtual item in the first item container is displayed in the item display area of the first item container. Usually, the area size of the item display area is limited. If there are many virtual items in the first item container, only part of the virtual items can be displayed in the item display area, and the player can make other virtual items display in the item display area by operating the slider, turning pages, etc.

If the above-mentioned second item container includes multiple types, the item display area of the second item container can be divided into multiple sub-areas, such as a backpack area, a safe box area, and an equipment bar area. Each sub-area can be preset with a designated space to limit the virtual items that the virtual controlled object carries to the game match.

Due to the different functions of the two containers, the item display areas of the first item container and the second item container are separated from each other, or a certain distance can be preset so that the player can clearly know the virtual item contained in each container.

The above-mentioned display control method for the virtual item includes the following steps:

Step S102, in response to a moving operation for a first virtual item in the first item container, controlling the first virtual item to move from the first item container to the second item container.

The first virtual item can be any item in the first item container. In this embodiment, the first virtual item is a virtual item that needs to be used in combination with other virtual items. For example, if the first virtual item is a firearm, the associated item of the first virtual item is bullets used in combination with the firearm; for another example, if the first virtual item is a bow, the associated item of the first virtual item is arrows used in combination with the bow. In the game, the association relationship between the first virtual item and the associated item of the first virtual item can be preset. By searching the association relationship, it can be determined whether the first virtual item is configured with an associated item and the item identifier of the associated item.

In the above graphical user interface, the first virtual item is displayed in the item display area of the first item container, or the first virtual item is made to be displayed in the item display area of the first item container through a sliding operation or a page turning operation by the player. The moving operation for the first virtual item may be specifically a drag operation acting on the first virtual item, or a single-click operation, a double-click operation, etc. acting on the first virtual item. Taking the drag operation as an example, after the first virtual item is dragged out of the grid of the first item container, the first virtual item moves along with the contact point of the drag operation. After the first virtual item moves to the second item container, the player performs a drag-and-release operation, and the first virtual item is placed in the second item container.

If the second item container includes multiple grids, the first virtual item is placed in any grid, or in a grid near the position where the drag-and-release operation occurs. If the second item container is divided into multiple sub-areas, the first virtual item is placed in the grid of the corresponding sub-area according to the item type of the first virtual item.

Step S104, determining that the associated item of the first virtual item is located outside the second item container, and displaying an information prompt mark, where the associated item is an item used in combination with the first virtual item in the game match, and the information prompt mark is configured to prompt the storage status of the associated item in the first item container.

When the first virtual item is moved to the second item container, it can be understood that the controlled virtual object subsequently carries the first virtual item to the game match. In order to enable the first virtual item to be used normally in the game match, after the first virtual item is moved to the second item container, the game system can detect whether the first virtual item has an associated item, and if so, detect whether the associated item is located in the second item container. Only when both the first virtual item and the associated item are located in the second item container, the controlled virtual object can carry the first virtual item and the associated item to the game match at the same time, and the first virtual item can be used normally in the game match. It can be understood that the associated item is an item used in combination with the first virtual item in the game match. For example, for a firearm, the associated item is bullets; and for a potion, the associated item is a cotton wool, etc.

If the associated item of the first virtual item is located outside the second item container, in order to prompt the player, in this embodiment, an information prompt mark is displayed. The information prompt mark is configured to prompt the storage status of the associated item in the first item container. The storage status may include whether the associated item exists in the first item container, the position and quantity of the associated item in the first item container, etc. On the one hand, the information prompt mark can prevent the player from forgetting to move the associated item to the second item container, and on the other hand, it can facilitate the player to quickly and accurately find the associated item from the first item container.

In the above display control method for the virtual item, in response to the moving operation for the first virtual item in the first item container, controlling the first virtual item to move from the first item container to the second item container; and determining that the associated item of the first virtual item is located outside the second item container, and displaying the information prompt mark; where the associated item is an item used in combination with the first virtual item in the game match, and the information prompt mark is configured to prompt the storage status of the associated item in the first item container. In this method, the second item container holds the virtual item carried to the game match. After the first virtual item is moved to the second item container, if the associated item of the first virtual item is not in the second item container, an information prompt mark is displayed. The information prompt mark prompts the storage status of the associated item in the first item container. On the one hand, it can prevent the player from forgetting to move the associated item to the second item container. On the other hand, it can facilitate the player to quickly and accurately find the associated item from the first item container, ensuring the normal use of the first virtual item in the game match, thereby improving the player's game performance and game experience, reducing the response frequency of the hardware device, and helping to save the computing resources of the hardware device.

The following embodiment describes a specific implementation method of displaying the information prompt mark.

In one method, it is determined that the associated item of the first virtual item is located outside the second item container. In response to a first trigger operation for the first virtual item, determining that the associated item is located in the first item container, and displaying a first prompt mark; where the first prompt mark is configured to prompt the position of the associated item in the first item container.

In this method, if the game system detects that the associated item of the first virtual item is located outside the second item container, the above-mentioned first prompt mark is not directly displayed. However, in order to prompt the player that the associated item is located outside the second item container, other prompt marks can be used for prompting. The first trigger operation may be a click operation on the first virtual item. That is, after the first virtual item is placed in the second item container, the player clicks or double-clicks the first virtual item again, and at this time, the first prompt mark is displayed. The first prompt mark is configured to indicate the position of the associated item in the first item container. The premise for displaying the first prompt mark is that there is an associated item of the first virtual item in the first item container. If there is no associated item in the first item container, other prompt marks may be used for prompting.

The first prompt mark may be text, symbol, highlight or other dynamic effects, which are configured to indicate the position of the associated item in the first item container, so that the player can quickly find the associated item of the first virtual item and avoid the player from finding the wrong associated item.

In actual implementation, in the item display area of the first item container, the associated item and/or the placement position of the associated item are displayed in the first display format. The first display format may be highlighting display, edge diffusion, streamer dynamic effect, etc. Usually, the first display format is different from the display format of other items or the placement position of items in the first item container. In actual implementation, only the associated item or the placement position of the associated item may be displayed in the first display format, or both the associated item and the placement position of the associated item may be displayed in the first display format.

As an example, FIG. 2 shows that the first virtual item is a firearm, and the first virtual item is located in the equipment column of the second item container. At this time, when the player performs a click operation on the first virtual item, the placement grid of the associated item is highlighted in the first item container. By highlighting, the player can be prompted with the position of the associated item in the first item container, so that the player can quickly find the correct associated item of the first virtual item.

This method can prompt the player with the placement position of the associated item, so that the player can quickly find the correct associated item of the first virtual item, and simplify the user's operation for selecting items.

Further, after prompting the position of the associated item in the first item container by the aforementioned first prompt mark, the player can perform a moving operation for the associated item, which is similar to the moving operation for the first virtual item, so that the associated item is also moved to the second item container.

In addition, in order to improve the convenience of the moving operation of the associated item, in this embodiment, in response to a second trigger operation for the first virtual item, the associated item is controlled to move from the first item container to the second item container. The second trigger operation can be pre-set as a single-click operation or a double-click operation. After the first prompt mark is displayed, when the second trigger operation is performed on the first virtual item, the associated item is moved from the first item container to the second item container. This method can improve the efficiency of moving the associated item and save the time of the player selecting equipment.

Considering that the space of the second item container is limited, when the number of the associated items in the first item container is large, the number of associated items to be moved can be considered when moving the associated items. For example, the associated items are bullets, and there may be 1,000 bullets in the first item container, while the second item container cannot hold 1,000 bullets. In this case, the number of associated items moved to the second item container needs to be considered.

Specifically, in response to a first control operation on the first virtual item, the associated items of the specified unit number are controlled to move from the first item container to the second item container; and in response to a second control operation on the first virtual item, the step of controlling the associated items of the specified unit number to move from the first item container to the second item container is continued until all the associated items in the first item container are moved to the second item container.

The aforementioned specified unit number can be preset, for example, as 50, 100, etc. The aforementioned first control operation and the second control operation can be specifically clicking operations such as single-click operation and double-click operation, or can also be other operation gestures. Taking the single-click operation as an example, in actual implementation, when the player performs a single-click operation on the first virtual item for one time, associated items of the specified unit number move from the first item container to the second item container. At this time, the number of associated items in the first item container decreases by the specified unit number, and the number of associated items in the second item container increases by the specified unit number; then, when the player performs a single-click operation on the first virtual item again, associated items of the specified unit number continue to move from the first item container to the second item container. At this time, the number of associated items in the first item container continues to decrease by the specified unit number, and the number of associated items in the second item container continues to increase by the specified unit number. In one example, the specified unit number is 100. Each time the player clicks on the first virtual item, 100 associated items move from the first item container to the second item container until all the associated items in the first item container are moved to the second item container.

The above method can improve the moving efficiency of associated items while allowing the player to adjust the number of associated items, further improving the efficiency for player's equipment selection.

In the aforementioned embodiment, after the player performs the first trigger operation on the first virtual item, when there is an associated item in the first item container, the first prompt mark is displayed. However, if there is no associated item in the first item container, in response to the first trigger operation for the first virtual item, it is determined that the associated item is located outside the first item container, and a second prompt mark is displayed. The second prompt mark is configured to prompt that there is no associated item in the first item container. The second prompt mark can be text, symbol, highlight or other dynamic effect. After the second prompt mark is displayed, the player can know that there is no associated item in the first item container. If the player wants to continue to use the first virtual item, he/she needs to purchase or obtain the associated item through other means.

In addition, when the associated item of the first virtual item is located outside the second item container, in addition to displaying the aforementioned information prompt mark prompting the storage status of the associated item in the first item container, a prompt mark prompting the storage status of the associated item in the second item container can also be displayed. Specifically, it is determined that the associated item of the first virtual item is located outside the second item container, and a third prompt mark is displayed; where the third prompt mark is configured to prompt that there is no associated item in the second item container.

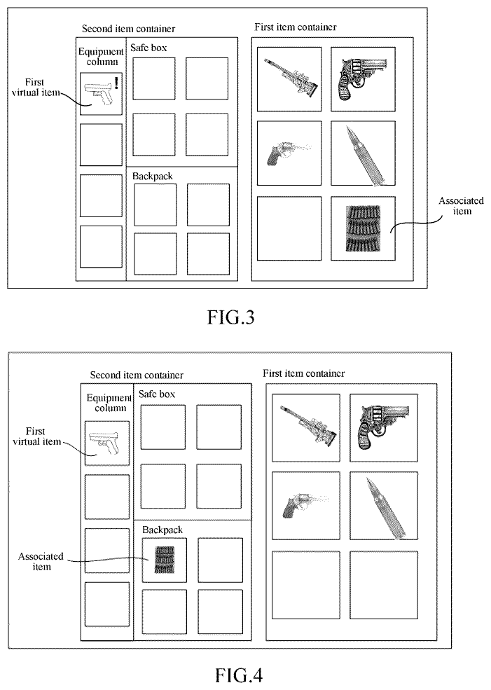

As an example, FIG. 3 shows that the first virtual item is located in the equipment column of the second item container, but there is no associated item of the first virtual item in the second item container. At this time, a “!” mark is displayed at the upper right corner of the first virtual item, which is the third prompt mark, indicating that there is no associated item in the second item container.

In response to the moving operation for the associated item in the first item container, the associated item is controlled to move from the first item container to the second item container; and the display of the third prompt mark is canceled. As shown in FIG. 4, the associated item of the first virtual item is moved from the first item container to the equipment column of the second item container. At this time, the third prompt mark, that is, the “!” mark is no longer displayed.

Through the above method, the player can be further reminded whether the associated item has been placed in the second item container, so as to avoid the player forgetting to carry the associated item, ensure that the first virtual container can be used normally with the associated item in the game match, and improve the error-proofing of the operation.

The above embodiment describes the display modes and functions of various information prompt marks after the first virtual item is moved from the first item container to the second item container. In the following embodiment, when the first virtual item is located in the first item container, the relevant status of the associated item is prompted by the prompt mark.

Specifically, in response to the first virtual item being displayed in the item display area of the first item container, it is determined that the associated item of the first virtual item is located outside the first item container and the second item container, and a fourth prompt mark is displayed; where the fourth prompt mark is configured to prompt that there are no associated items in both the first item container and the second item container.

In this case, the first virtual item is still in the first item container. In order to let the player know the status of the associated items of the first virtual item, when the first virtual item is displayed in the item display area of the first item container, the game system detects whether the associated item of the first virtual item is located in the first item container or the second item container. If the associated item is located in the first item container or the second item container, or the first item container and the second item container both contain the associated item, then it means that the player's account has the associated item of the first virtual item, and the first virtual item can be used normally. However, if there is no associated item in both the first item container and the second item container, it means that the player's account does not have the associated item. At this time, even if the first virtual item is moved to the second item container and brought into the game match, the first virtual item cannot be used. The moving operation of the first virtual item to the second item container becomes an invalid operation. In order to avoid the invalid operation, when the first virtual item is in the first item container, the aforementioned fourth prompt mark is displayed to prompt that there is no associated item in the first item container and the second item container.

As an example, FIG. 5 shows that the first virtual item is located in the first item container. The first virtual item is a firearm. There is no bullet matching the firearm in the first item container and the second item container, that is, the associated item of the first virtual item. At this time, the “Δ” mark, that is, the fourth prompt mark, is displayed in the upper right corner of the first virtual item to prompt that there is no associated item in the first item container and the second item container.

This method prompts that the associated item of the first virtual item does not exist, avoids the player from moving the first virtual item, and reduces invalid operations.

Further, in response to a third trigger operation for the first virtual item, an operation control is displayed at a specified position of the first virtual item; where the operation control is configured to provide an interface for obtaining the associated item.

The third trigger operation can be a single-click operation, a double-click operation, or a short-distance drag operation along a specific direction acted on the first virtual item. Since there is no associated item of the first virtual item in the player's account, the operation control is displayed at the specified position of the first virtual item through the third trigger operation. For example, after double-clicking the first virtual item, the operation control is displayed near the first virtual item; the operation control can be a purchase control for the associated item. When the player clicks the operation control, the item purchase page of the associated item is displayed, and the associated item is obtained by purchase. In addition, the operation control can also provide other ways to obtain the associated item, such as item exchange. After the player clicks the operation control, the associated item provided by other players and the player's exchange item requirement are displayed. The current player gives his other items to the other player in exchange for the associated item.

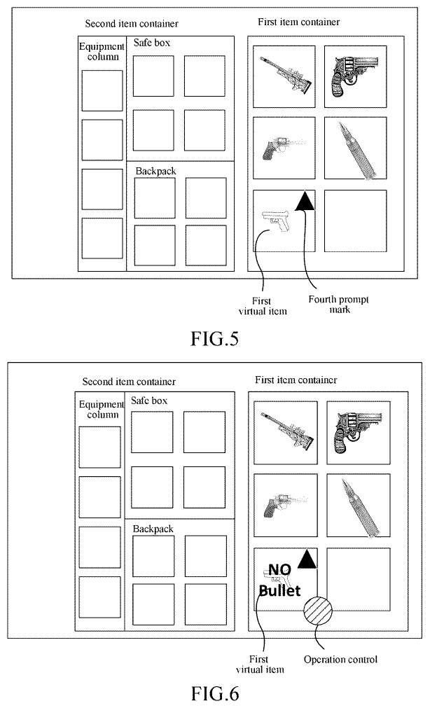

At the same time, when the reference control is displayed, the player can be further informed that the first virtual item has no associated item by means of prompt text. As an example, in FIG. 6, when the player clicks the first virtual item, the prompt text “NO Bullet” is displayed on the icon of the first virtual item, i.e., the firearm, to inform that the firearm has no corresponding bullet. At the same time, the operation control is displayed in the lower right corner of the first virtual item.

In this method, by providing the operation control, the player can quickly and conveniently obtain the associated item without having to exit the current page and enter other pages to obtain the associated item.

In addition, in the game match, the status of the associated item can also be prompted through relevant prompt information. Specifically, in response to the operation of entering the game match, the game scene screen is displayed in the graphical user interface; in response to the display operation for the second item container, the item display area of the second item container is displayed; it is determined that there is no associated item in the second item container, and the fifth prompt mark is displayed; where the fifth prompt mark is configured to prompt that there is no associated item in the second item container.

After the player selects the equipment, the page displaying the first item container and the second item container can be closed, and the use can participate in the game match by clicking the relevant controls. In the process of participating in the game match, the game scene screen and various operation controls are displayed in the graphical user interface. In the process of participating in the game match, some virtual items may be consumed, such as consumables like bullets and medicines.

The player carries the second item container to participate in the game match. In the process of participating in the game match, the player can open the second item container to view the usage status of various virtual items, take and replace virtual items, etc. The player can open the second item container through the relevant controls on the graphical user interface. After the second item container is opened, the item display area of the second item container is displayed on the graphical user interface. When there is no associated item of the first virtual item in the second item container, the fifth prompt mark is displayed at this time, prompting that there is no associated item in the second item container, so that the player can replace the first virtual item with other virtual items. For example, for firearms, it can be replaced with other models of firearms.

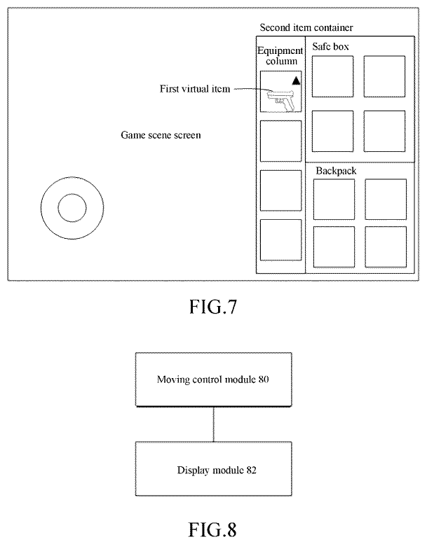

FIG. 7 is used as an example. In the game match, after the second item container is opened, when there is no associated item of the first virtual item in the second item container, the “Δ” mark, that is, the aforementioned fifth prompt mark, is displayed to prompt that the associated item of the first virtual item has been exhausted. When the player continues to click on the first virtual item, a text prompt is displayed, that is, it further prompts that the associated item of the first virtual item has been exhausted.

This method can let the player know the status of the associated item in the game match immediately, so as to replace the virtual item in use immediately, simplifying the operation of the player to obtain the status information related to the items.

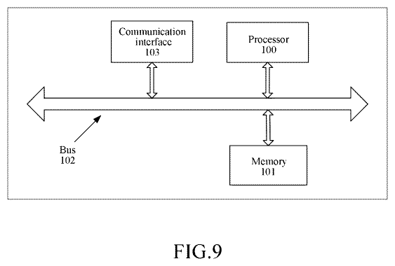

Corresponding to the aforementioned method embodiment, FIG. 8 shows a structural schematic diagram of a display control device for a virtual item. A graphical user interface is provided through a terminal device; the graphical user interface includes an item display area of a first item container and an item display area of a second item container; where the first item container is configured to hold a virtual item possessed by the controlled virtual object outside the game match; the second item container is configured to hold a virtual item carried by the controlled virtual object into the game match; the device includes:
a moving control module 80, configured to control a first virtual item to move from the first item container to the second item container in response to a moving operation for the first virtual item in the first item container; and
a display module 82, configured to determine that an associated item of the first item container is located outside the second item container, and display an information prompt mark; where the associated item is an item used in combination with the first virtual item in the game match; and the information prompt mark is configured to prompt the storage status of the associated item in the first item container.

The display control device for the virtual item is configured to, in response to the moving operation for the first virtual item in the first item container, control the first virtual item to move from the first item container to the second item container; determine that an associated item of the first virtual item is located outside the second item container, and display an information prompt mark; where the associated item is an item used in combination with the first virtual item in the game match; and the information prompt mark is configured to prompt the storage status of the associated item in the first item container. In this method, the second item container holds the virtual item carried to the game match, and when the first virtual item is moved to the second item container, if the associated item of the first virtual item is not in the second item container, then the information prompt mark is displayed, and the information prompt mark prompts the storage status of the associated item in the first item container, which can prevent the player from forgetting to move the associated item to the second item container, and can also facilitate the player to quickly and accurately find the associated item from the first item container, so as to ensure the normal use of the first virtual item in the game match, thereby improving the player's game performance and game experience, reducing the response frequency of the hardware device, and helping to save the computing resources of the hardware device.

The display module is further configured to determine that the associated item of the first virtual item is located outside the second item container, in response to the first trigger operation for the first virtual item, determine that the associated item is located in the first item container, and display a first prompt mark; where the first prompt mark is configured to prompt the position of the associated item in the first item container.

The display module is further configured to display the associated item and/or the placement position of the associated item in the item display area of the first item container in a first display format.

The device further includes a second control module, configured to control the associated item to move from the first item container to the second item container in response to a second trigger operation for the first virtual item.

The second control module is further configured to control the associated items of a specified unit number to move from the first item container to the second item container in response to the first control operation for the first virtual item; continue to execute the step of controlling the associated items of a specified unit number to move from the first item container to the second item container in response to the second control operation for the first virtual item, until all the associated items in the first item container are moved to the second item container.

The above-mentioned device further includes a first mark display module, configured to determine that the associated item is located outside the first item container in response to the first trigger operation for the first virtual item, and display a second prompt mark; where the second prompt mark is configured to prompt that there is no associated item in the first item container.

The above-mentioned device further includes a second mark display module, configured to determine that the associated item of the first virtual item is located outside the second item container, and display a third prompt mark; where the third prompt mark is configured to prompt that there is no associated item in the second item container.

The above-mentioned device further includes a canceling display module, configured to control the associated item to move from the first item container to the second item container in response to the moving operation for the associated item in the first item container; and cancel the display of the third prompt mark.

The above-mentioned device further includes a third mark display module, configured to determine that the associated item of the first virtual item is located outside the first item container and the second item container in response to the first virtual item being displayed in the item display area of the first item container, and display a fourth prompt mark; where the fourth prompt mark is configured to prompt that there is no associated item in both the first item container and the second item container.

The above-mentioned device further includes a control display module, configured to display an operation control at the specified position of the first virtual item in response to a third trigger operation on the first virtual item; where the operation control is configured to provide an interface for obtaining the associated item.

The above-mentioned device further includes a fourth mark display module, configured to display the game scene screen in the graphical user interface in response to the operation of entering the game match; display the item display area of the second item container in response to the display operation for the second item container; determine that there is no associated item in the second item container, and display a fifth prompt mark; where the fifth prompt mark is configured to prompt that there is no associated item in the second item container.

This embodiment also provides an electronic device, including a processor and a memory, the memory stores machine executable instructions that can be executed by the processor, and the processor executes the machine executable instructions to implement the above-mentioned display control method for the virtual item. The electronic device can be a server or a terminal device.

As shown in FIG. 9, the electronic device includes a processor 100 and a memory 101. The memory 101 stores machine executable instructions that can be executed by the processor 100, and the processor 100 executes the machine executable instructions to implement the above-mentioned display control method for the virtual item.

Furthermore, the electronic device shown in FIG. 9 further includes a bus 102 and a communication interface 103, and the processor 100, the communication interface 103 and the memory 101 are connected through the bus 102.

The memory 101 may include a high-speed random access memory (RAM), and may also include a non-volatile memory, such as at least one disk storage. The communication connection between the system network element and at least one other network element is realized through at least one communication interface 103 (which may be wired or wireless), and the Internet, wide area network, local area network, metropolitan area network, etc. can be used. The bus 102 may be an ISA bus, a PCI bus or an EISA bus, etc. The bus can be classified into an address bus, a data bus, a control bus, etc. For ease of representation, only one bidirectional arrow is used in FIG. 9, but it does not mean that there is only one bus or one type of bus.

The processor 100 may be an integrated circuit chip with a signal processing capability. In the implementation process, each step of the above method can be completed by an integrated logic circuit of hardware or instructions in software form in the processor 100. The above-mentioned processor 100 can be a general-purpose processor, including a central processing unit (CPU), a network processor (NP), etc.; it can also be a digital signal processor (DSP), an application specific integrated circuit (ASIC), a field programmable gate array (FPGA), or other programmable logic devices, discrete gates or transistor logic devices, discrete hardware components. The methods, steps, and logic block diagrams disclosed in the embodiments of the present disclosure can be implemented or executed. The general-purpose processor can be a microprocessor or the processor can also be any conventional processor. The steps of the method disclosed in the embodiments of the present disclosure can be directly executed by a hardware decoding processor, or executed by a combination of the hardware and software modules in the decoding processor. The software module can be located in a mature storage medium in the art such as a random access memory, a flash memory, a read-only memory, a programmable read-only memory, or an electrically erasable programmable memory, a register, etc. The storage medium is located in the memory 101, and the processor 100 reads the information in the memory 101 and completes the steps of the method of the aforementioned embodiment in combination with its hardware.

The processor in the electronic device can implement the following operations in the display control method for the virtual item by executing the machine executable instructions:
provide a graphical user interface through a terminal device; the graphical user interface includes an item display area of the first item container and an item display area of the second item container; where the first item container is configured to hold a virtual item possessed by the controlled virtual object outside the game match; the second item container is configured to hold a virtual item that the controlled virtual object carries into the game match; in response to a moving operation for the first virtual item in the first item container, control the first virtual item to move from the first item container to the second item container; determining that an associated item of the first virtual item is located outside the second item container, and display an information prompt mark; where the associated item is an item used in combination with the first virtual item in the game match; the information prompt mark is configured to prompt the storage status of the associated item in the first item container.

In the above-mentioned display control method for the virtual item, in response to the moving operation for the first virtual item in the first item container, controlling the first virtual item to move from the first item container to the second item container; determining that an associated item of the first virtual item is located outside the second item container, and displaying an information prompt mark; where the associated item is an item used in combination with the first virtual item in the game match; the information prompt mark is configured to prompt the storage status of the associated item in the first item container. In this method, the second item container contains the virtual item carried to the game match. When the first virtual item is moved to the second item container, if the associated item of the first virtual item is not in the second item container, an information prompt mark is displayed, and the information prompt mark prompts the storage status of the associated item in the first item container. On the one hand, it can prevent players from forgetting to move the associated item to the second item container, and on the other hand, it can facilitate players to quickly and accurately find the associated item from the first item container, ensuring the normal use of the first virtual item in the game match, thereby improving the player's game performance and game experience, reducing the response frequency of the hardware device, and helping to save the computing resources of the hardware device.

Determine that the associated item of the first virtual item is located outside the second item container, and in response to the first trigger operation for the first virtual item, determine that the associated item is located in the first item container, and displaying a first prompt mark; where the first prompt mark is configured to prompt the position of the associated item in the first item container.

This method can prompt the player of the placement position of the associated item, facilitate the player to quickly find the correct associated item of the first virtual item, and simplify the user's operation of selecting items.

In the item display area of the first item container, the associated item and/or the placement position of the associated item are displayed in the first display format.

In response to the second trigger operation for the first virtual item, controlling the associated item to move from the first item container to the second item container.

This method can improve the efficiency of moving the associated item and save the time of the player for selecting equipment.

In response to the first control operation for the first virtual item, controlling the associated items of a specified unit number to move from the first item container to the second item container; in response to the second control operation for the first virtual item, continuing to execute the step of controlling the associated items of a specified unit number to move from the first item container to the second item container until all the associated items in the first item container are moved to the second item container.

The above method can improve the moving efficiency of the associated items while allowing the player to adjust the number of associated items, further improving the efficiency of the player's equipment selection.

In response to the first trigger operation for the first virtual item, it is determined that the associated item is located outside the first item container, and a second prompt mark is displayed; where the second prompt mark is configured to prompt that there is no associated item in the first item container.

It is determined that the associated item of the first virtual item is located outside the second item container, and a third prompt mark is displayed; where the third prompt mark is configured to prompt that there is no associated item in the second item container.

Through the above method, the player can be further reminded whether the associated item has been placed in the second item container, so as to avoid the player forgetting to bring the associated item, ensure that the first virtual item can be used normally with the associated item in the game match, and improve the error-proofing of the operation.

In response to the moving operation for the associated item in the first item container, the associated item is controlled to move from the first item container to the second item container; and the display of the third prompt mark is canceled.

In response to the first virtual item being displayed in the item display area of the first item container, it is determined that the associated item of the first virtual item is located outside the first item container and the second item container, and a fourth prompt mark is displayed; where the fourth prompt mark is configured to prompt that there is no associated item in both the first item container and the second item container.

This method prompts that the associated item of the first virtual item does not exist, avoids the player from moving the first virtual item, and reduces invalid operations.

In response to the third trigger operation for the first virtual item, an operation control is displayed at the specified position of the first virtual item; where the operation control is configured to provide an interface for obtaining the associated item.

In this method, by providing the operation control, it is convenient for the player to quickly and conveniently obtain the associated item, without exiting the current page and entering other pages to obtain the associated item.

In response to the operation of entering the game match, the game scene screen is displayed in the graphical user interface; in response to the display operation for the second item container, the item display area of the second item container is displayed; it is determined that there is no associated item in the second item container, and a fifth prompt mark is displayed; where the fifth prompt mark is configured to prompt that there is no associated item in the second item container.

This method can let the player know the status of the associated item in the game match immediately, so as to replace the virtual item used immediately, simplifying the operation of the player to obtain the status information related to the item.

This embodiment also provides a machine-readable storage medium. The machine-readable storage medium stores machine-executable instructions, and when the machine-executable instructions are called and executed by the processor, the machine-executable instructions cause the processor to implement the above-mentioned display control method for the virtual item.

The machine executable instructions stored in the machine readable storage medium can realize the following operations in the display control method for the virtual item by executing the machine executable instructions:

Provide a graphical user interface through a terminal device; the graphical user interface includes an item display area of a first item container and an item display area of a second item container; where the first item container is configured to hold a virtual item possessed by the controlled virtual object outside the game match; the second item container is configured to hold a virtual item carried by the controlled virtual object into the game match; in response to a moving operation for the first virtual item in the first item container, control the first virtual item to move from the first item container to the second item container; determine that the associated item of the first virtual item is located outside the second item container, and display an information prompt mark; where the associated item is an item used in combination with the first virtual item in the game match; the information prompt mark is configured to prompt the storage status of the associated item in the first item container.

In the above-mentioned display control method for the virtual item, in response to the moving operation for the first virtual item in the first item container, control the first virtual item to move from the first item container to the second item container; determine that the associated item of the first virtual item is located outside the second item container, and display an information prompt mark; where the associated item is an item used in combination with the first virtual item in the game match; the information prompt mark is configured to prompt the storage status of the associated item in the first item container. In this method, the second item container holds the virtual item carried to the game match. When the first virtual item is moved to the second item container, if the associated item of the first virtual item is not in the second item container, an information prompt mark is displayed, and the information prompt mark prompts the storage status of the associated item in the first item container. On the one hand, it can prevent players from forgetting to move the associated item to the second item container, and on the other hand, it can facilitate the player to quickly and accurately find the associated item from the first item container, ensuring the normal use of the first virtual item in the game match, thereby improving the player's game performance and game experience, reducing the response frequency of the hardware device, and helping to save the computing resources of the hardware device.

Determine that the associated item of the first virtual item is located outside the second item container, and in response to the first trigger operation for the first virtual item, determine that the associated item is located in the first item container, and display a first prompt mark; where the first prompt mark is configured to prompt the position of the associated item in the first item container.

This method can prompt the player of the placement position of the associated item, facilitate the player to quickly find the correct associated item of the first virtual item, and simplify the user's operation of selecting items.

In the item display area of the first item container, the associated item and/or the placement position of the associated item is displayed in the first display format.

In response to the second trigger operation for the first virtual item, the associated item is controlled to move from the first item container to the second item container.

This method can improve the efficiency of moving the associated item and save the time of the player for selecting equipment.

In response to the first control operation for the first virtual item, the associated items of a specified unit number is controlled to move from the first item container to the second item container; in response to the second control operation for the first virtual item, continue to execute the step of controlling the associated items of a specified unit number to move from the first item container to the second item container until all the associated items in the first item container are moved to the second item container.

The above method can improve the moving efficiency of the associated items while allowing the player to adjust the number of associated items, further improving the efficiency of the player's equipment selection.

In response to the first trigger operation for the first virtual item, it is determined that the associated item is located outside the first item container, and a second prompt mark is displayed; where the second prompt mark is configured to prompt that there is no associated item in the first item container.

It is determined that the associated item of the first virtual item is located outside the second item container, and a third prompt mark is displayed; where the third prompt mark is configured to prompt that there is no associated item in the second item container.

Through the above method, the player can be further reminded whether the associated item has been placed in the second item container, so as to avoid the player forgetting to bring the associated item, ensure that the first virtual container can be used normally with the associated item in the game match, and improve the error-proofing of the operation.

In response to the moving operation for the associated item in the first item container, the associated item is controlled to move from the first item container to the second item container; and the display of the third prompt mark is canceled.

In response to the first virtual item being displayed in the item display area of the first item container, it is determined that the associated item of the first virtual item is located outside the first item container and the second item container, and a fourth prompt mark is displayed; where the fourth prompt mark is configured to prompt that there is no associated item in both the first item container and the second item container.

This method prompts that the associated item of the first virtual item does not exist, avoids the player from moving the first virtual item, and reduces invalid operations.

In response to the third trigger operation for the first virtual item, an operation control is displayed at the specified position of the first virtual item; where the operation control is configured to provide an interface for obtaining the associated item.

In this method, by providing the operation control, it is convenient for the player to quickly and conveniently obtain the associated item, without exiting the current page and entering other pages to obtain the associated item.

In response to the operation of entering the game match, the game scene screen is displayed in the graphical user interface; in response to the display operation for the second item container, the item display area of the second item container is displayed; it is determined that there is no associated item in the second item container, and a fifth prompt mark is displayed; where the fifth prompt mark is configured to prompt that there is no associated item in the second item container.

This method can let the player know the status of the associated item immediately in the game match, so as to immediately replace the virtual item used, simplifying the operation of the player to obtain the status information related to the item.

The display control method, device and computer program product of the electronic device for the virtual item provided by the embodiment of the present disclosure include a computer-readable storage medium storing a program code, and the instructions included in the program code can be configured to execute the method described in the previous method embodiment. The specific implementation can refer to the method embodiment, which will not be repeated here.

Those skilled in the art can clearly understand that for the convenience and simplicity of description, the specific working process of the system and device described above can refer to the corresponding process in the above method embodiment, which will not be repeated here.

In addition, in the description of the embodiment of the present disclosure, unless otherwise clearly specified and limited, the terms “install”, “connect” and “couple” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal connection of two components. For those skilled in the art, the specific meanings of the above terms in the present disclosure can be understood according to the specific situation.

If the function is implemented in the form of a software functional unit and sold or used as an independent product, it can be stored in a computer-readable storage medium. Based on such understanding, the technical solution of the present disclosure, or the part that contributes to the related art, or the part of the technical solution, can be embodied in the form of a software product, which is stored in a storage medium and includes several instructions for a computer device (which can be a personal computer, a server, or a network device, etc.) to perform all or part of the steps of the method described in each embodiment of the present disclosure. The aforementioned storage medium includes various media that can store program codes such as U disk, mobile hard disk, read-only memory (ROM, Read-Only Memory), random access memory (RAM, Random Access Memory), disk or optical disk, etc.

In the description of the present disclosure, it should be noted that the terms “center”, “up”, “down”, “left”, “right”, “vertical”, “horizontal”, “inside”, “outside” and the like indicate the orientation or position relationship based on the orientation or position relationship shown in the accompanying drawings, which is only for the convenience of describing the present disclosure and simplifying the description, rather than indicating or implying that the device or element referred to must have a specific orientation, be constructed and operated in a specific orientation, and therefore cannot be understood as a limitation on the present disclosure. In addition, the terms “first”, “second” and “third” are only used for descriptive purposes and cannot be understood as indicating or implying relative importance.

Finally, it should be noted that the above embodiments are only specific implementation methods of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any person skilled in the art who is familiar with the technical field can still modify the technical solutions recorded in the above embodiments within the technical scope disclosed in the present disclosure, or can easily think of changes, or make equivalent replacements for some of the technical features therein; and these modifications, changes or replacements do not make the essence of the corresponding technical solutions deviate from the spirit and scope of the technical solutions of the embodiments of the present disclosure, and should be covered within the protection scope of the present disclosure. Therefore, the protection scope of the present disclosure shall be subject to the protection scope of the claims.

1. A display control method for a virtual item, comprising:
providing a graphical user interface through a terminal device, wherein the graphical user interface comprises an item display area of a first item container and an item display area of a second item container, the first item container is configured to hold a virtual item possessed by a controlled virtual object outside a game match, and the second item container is configured to hold a virtual item carried by the controlled virtual object into the game match;
in response to a moving operation for a first virtual item in the first item container, controlling the first virtual item to move from the first item container to the second item container; and
determining that an associated item of the first virtual item is located outside the second item container, and displaying an information prompt mark, wherein the associated item is an item used in combination with the first virtual item in the game match, and the information prompt mark is configured to prompt a storage status of the associated item in the first item container.

2. The method according to claim 1, wherein determining that the associated item of the first virtual item is located outside the second item container and displaying the information prompt mark comprises:
determining that the associated item of the first virtual item is located outside the second item container, and in response to a first trigger operation for the first virtual item, determining that the associated item is located in the first item container, and displaying a first prompt mark, wherein the first prompt mark is configured to prompt a position of the associated item in the first item container.

3. The method according to claim 2, wherein displaying the first prompt mark comprises:
displaying at least one of the associated item or a placement position of the associated item in a first display format in the item display area of the first item container.

4. The method according to claim 2, further comprising:
in response to a second trigger operation for the first virtual item, controlling the associated item to move from the first item container to the second item container.

5. The method according to claim 4, wherein the associated item comprises a plurality of associated items, and wherein in response to the second trigger operation for the first virtual item, controlling the associated item to move from the first item container to the second item container comprises:
in response to a first control operation for the first virtual item, controlling the plurality of associated items of a specified unit number to move from the first item container to the second item container; and
in response to a second control operation for the first virtual item, continuing to perform the step of controlling the plurality of associated items of the specified unit number to move from the first item container to the second item container until all the plurality of associated items in the first item container are moved to the second item container.

6. The method according to claim 2, further comprising:
in response to the first trigger operation for the first virtual item, determining that the associated item is located outside the first item container, and displaying a second prompt mark, wherein the second prompt mark is configured to prompt that the associated item is located outside the first item container.

7. The method according to claim 1, further comprising:
determining that the associated item of the first virtual item is located outside the second item container, and displaying a third prompt mark, wherein the third prompt mark is configured to prompt that the associated item is located outside the second item container.

8. The method according to claim 7, further comprising:
in response to a moving operation for the associated item in the first item container, controlling the associated item to move from the first item container to the second item container; and
canceling the display of the third prompt mark.

9. The method according to claim 1, further comprising:
in response to the first virtual item being displayed in the item display area of the first item container, determining that the associated item of the first virtual item is located outside the first item container and the second item container, and displaying a fourth prompt mark, wherein the fourth prompt mark is configured to prompt that the associated item is located outside both the first item container and the second item container.

10. The method according to claim 9, further comprising:
in response to a third trigger operation for the first virtual item, displaying an operation control at a specified position of the first virtual item, wherein the operation control is configured to provide an interface for obtaining the associated item.

11. The method according to claim 1, further comprising:
in response to an operation of entering the game match, displaying a game scene screen in the graphical user interface;
in response to a display operation for the second item container, displaying the item display area of the second item container; and
determining that the associated item is not in the second item container, and displaying a fifth prompt mark, wherein the fifth prompt mark is configured to prompt that the associated item is located outside the second item container.

12. (canceled)

13. An electronic device, comprising a processor and a memory, wherein the memory stores machine executable instructions that can be executed by the processor, and by executing the machine executable instructions, the processor is configured to:
provide a graphical user interface through a terminal device, wherein the graphical user interface comprises an item display area of a first item container and an item display area of a second item container, the first item container is configured to hold a virtual item possessed by a controlled virtual object outside a game match, and the second item container is configured to hold a virtual item carried by the controlled virtual object into the game match;
in response to a moving operation for a first virtual item in the first item container, control the first virtual item to move from the first item container to the second item container; and
determine that an associated item of the first virtual item is located outside the second item container, and display an information prompt mark, wherein the associated item is an item used in combination with the first virtual item in the game match, and the information prompt mark is configured to prompt a storage status of the associated item in the first item container.

14. A non-transitory machine-readable storage medium stores machine-executable instructions, which, when called and executed by a processor, cause the processor to:
provide a graphical user interface through a terminal device, wherein the graphical user interface comprises an item display area of a first item container and an item display area of a second item container, the first item container is configured to hold a virtual item possessed by a controlled virtual object outside a game match, and the second item container is configured to hold a virtual item carried by the controlled virtual object into the game match;
in response to a moving operation for a first virtual item in the first item container, control the first virtual item to move from the first item container to the second item container; and
determine that an associated item of the first virtual item is located outside the second item container, and display an information prompt mark, wherein the associated item is an item used in combination with the first virtual item in the game match, and the information prompt mark is configured to prompt a storage status of the associated item in the first item container.

15. The electronic device according to claim 13, wherein determining that the associated item of the first virtual item is located outside the second item container and displaying the information prompt mark comprises:
determining that the associated item of the first virtual item is located outside the second item container, and in response to a first trigger operation for the first virtual item, determining that the associated item is located in the first item container, and displaying a first prompt mark, wherein the first prompt mark is configured to prompt a position of the associated item in the first item container.

16. The electronic device according to claim 15, wherein displaying the first prompt mark comprises:
displaying at least one of the associated item or a placement position of the associated item in a first display format in the item display area of the first item container.

17. The electronic device according to claim 15, the processor is further configured to:
in response to a second trigger operation for the first virtual item, control the associated item to move from the first item container to the second item container.

18. The electronic device according to claim 17, wherein the associated item is provided in plural, and in response to the second trigger operation for the first virtual item, controlling the associated item to move from the first item container to the second item container comprises:
in response to a first control operation for the first virtual item, controlling the associated items of a specified unit number to move from the first item container to the second item container; and
in response to a second control operation for the first virtual item, continuing to perform the step of controlling the associated items of the specified unit number to move from the first item container to the second item container until all the associated items in the first item container are moved to the second item container.

19. The electronic device according to claim 15, the processor is further configured to:
in response to the first trigger operation for the first virtual item, determine that the associated item is located outside the first item container, and displaying a second prompt mark, wherein the second prompt mark is configured to prompt that the associated item is located outside the first item container.

20. The non-transitory machine-readable storage medium according to claim 14, the processor is further configured to:
determine that the associated item of the first virtual item is located outside the second item container, and display a third prompt mark, wherein the third prompt mark is configured to prompt that the associated item is located outside the second item container.

21. The non-transitory machine-readable storage medium according to claim 20, the processor is further configured to:
in response to a moving operation for the associated item in the first item container, control the associated item to move from the first item container to the second item container; and
cancel the display of the third prompt mark.
